(19) United States
(12) Patent Application Publication
(10) Pub. No.: US 2016/0232119 A1
(43) Pub. Date: Aug. 11, 2016

(54) SHARING MEMORY BETWEEN USB Enabled Devices

(71) Applicant: THOMSON LICENSING, Issy de Moulineaux (FR)

(72) Inventor: Paul G. Knutson, Westfield, IN (US)

(73) Assignee: Thomson Licensing

(21) Appl. No.: 14/843,165

(22) Filed: Sep. 23, 2015

Related U.S. Application Data
(60) Provisional application No. 62/051,458, filed on Sep. 17, 2014.

(51) Int. Cl. G06F 13/38; G06F 13/42; G06F 13/16; G06F 3/06

(52) U.S. Cl. CPC G06F 13/385; G06F 3/0622; G06F 3/0659; G06F 3/067; G06F 13/4282; G06F 13/1663

(57) ABSTRACT

At least one Universal Serial Bus (USB) device is coupled to shared memory. The memory is accessible via the at least one USB interface wherein the memory is configured to be shared between the at least one USB device, the memory configured with a memory arbiter, wherein the memory arbiter decides which of the at least one USB device can access a read-write memory space of the memory during a time period.

### BACKGROUND INFORMATION

Virtually every smartphone, tablet, and PC includes a Universal Serial Bus (USB) interface, and the majority of mobile phones include a USB interface. USB is an industry standard developed in the mid-1990s that defines the cables, connectors, and communications protocol used for connection, communication and power. USB has essentially replaced earlier interfaces such as serial and parallel ports as well as separate power ports. Consequently, two primary functions of a USB interface are charging and connecting a USB device to a PC or network interface. Practically every smartphone, tablet, and e-reader uses a USB port as a charging port. In other words, the device receives power to charge the internal battery/batteries through the USB port. In addition, a USB provides an interface to connect a device such as smartphone or tablet to a PC.

As consumers continue to purchase and rely on more and more of these consumer electronic devices, the ability to share or synchronize the data on these devices has become an essential requirement. For example, a user may connect their smartphone to a PC to transfer the contacts they have stored on their smartphone to the PC or vice versa. Another example is sharing data between devices where a user may have a word document, drawing, spreadsheet, and the like on their smartphone, tablet or PC that they want to transfer to another device. Thus, a user may have data fragmented between several devices.

Currently, if a user desires to share or transfer data between a device such as a smartphone and tablet, the user would have to connect to a PC, download the data, and then connect the other device and upload the data. This option uses the PC as a data-sharing mediator. There are a couple of disadvantages with this option. This option requires a PC, whenever a user desires, to share or transfer data and requires the somewhat tedious and time-consuming task of connecting and disconnecting each device to the PC. As more and more users are opting for a tablet computing device the PC is becoming less common. A user may choose a memory device such as a USB memory stick, but again, the user is forced to connect one device to the USB memory stick to download data and then connect the other device to the USB memory stick to upload the data. Another option is to use an Internet storage device as a data-sharing mediator to download data from one device and upload the data on another device. There are several disadvantages to this option. This option requires a wireless communication network or a Wireless Local Area Network (WLAN) for a smartphone to connect to the Internet, and a WLAN for a tablet, e-reader, and the like to connect to the Internet. In addition, there may be security concerns since the data is accessible through the Internet. Also, these options simply provide a place to store data where the data can later be retrieved. These solutions also may not allow real time read-write access between devices, and they may not provide means for synchronizing data between devices. Consequently, a user does not have the means to easily and conveniently share information and data between USB enabled devices.

Accordingly, there is a need for providing shared memory through a USB interface.

### SUMMARY

The example embodiments of the present principles provide methods and apparatuses directed to a shared memory apparatus for coupling one or more Universal Serial Bus (USB) devices to the shared memory apparatus. The shared memory apparatus includes at least one USB interface and memory accessible via the at least one USB interface wherein the memory is configured to be shared between the one or more USB devices, the memory configured with a memory arbiter, wherein the memory arbiter controls which of the one or more USB enabled devices can access a read-write memory space of the memory during a time period.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

### BRIEF DESCRIPTION OF THE DRAWINGS

FIG. 1 depicts an example embodiment of a shared memory device interfaced with several USB enabled devices in accordance with the present principles.

FIG. 2 depicts a shared memory device in accordance with example embodiments of the present principles.

FIG. 3 illustrates a flow diagram of a USB enumeration process of an embodiment of the present principles.

### DETAILED DESCRIPTION

The foregoing and other aspects of the example embodiments to accomplish the foregoing are further explained in this Detailed Description when read in conjunction with the attached Drawing Figures. These aspects are indicative of several of the various ways in which the principles of the subject matter may be exercised. The subject matter disclosed is intended to include all such aspects and their equivalents.

A Universal Serial Bus (USB) provides an easy to use interface that supports a plug-and-play connection. Plug-and-play refers to a specification that enables the discovery of a hardware component such as a flash memory, a computer keyboard, smartphone, tablet, and the like without the need for physical device configuration. When a USB device is connected to a host, a USB device enumeration process is started. USB device enumeration is the process of detecting, identifying, and loading drivers for a USB device. The process involves hardware techniques for detecting the presence of a device and software to identify the device. A USB interface can consist of four wires including: power, ground, Data Plus (USBDP), and Data Minus (USBDM). A device capable of acting as a USB host uses a resistor to connect USBDP and USBDM to ground. When a USB device is coupled to a USB host, the USB host detects a change in USBDP and USBDM data lines. Once a device is detected, the host determines the device speed, what device is coupled to the host, the device configuration, and the device interface. After this process, the host loads a driver for the device that is coupled to the host.

USB specification 3.1 was released in July 2013 and supports signaling rates up to 10 Gbits/sec, and as with previous versions, USB 3.1 supports three power profiles. These power profiles are defined in the USB Power Delivery Specification. USB 3.1 is backward compatible with USB 3.0 and USB 2.0. The details related to the signaling and design architecture of USB are well known to those skilled in the art and are omitted for brevity.

A memory arbiter is used to manage memory requests from each individual processor in a multiple processor system where the multiple processors share memory. The memory arbiter manages the memory request of each processor prior to the request being sent to the shared memory. In the example embodiments described below, an equivalent to the multiple processors is USB enabled devices. Thus, each of the at least one USB enabled device is viewed similar to a processor in a multi-processor system, and the memory arbiter of the shared memory apparatus and method described below controls which USB enabled device can access memory at a give time. In other words, memory read/write access is controlled by a memory arbiter. A memory arbiter can be implemented using a semaphore. Although, when only one USB enabled device is coupled to the shared memory apparatus, memory arbitration is minimized

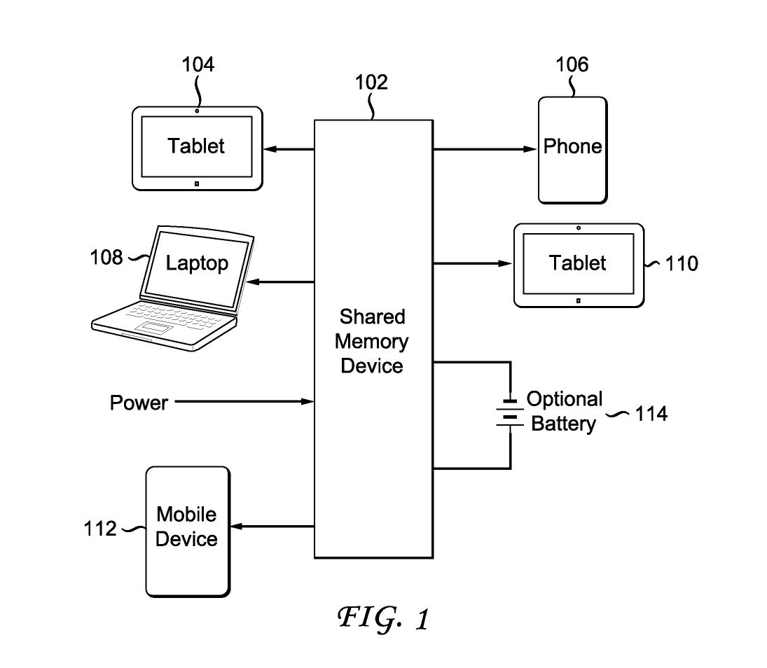

FIG. 1 depicts an example embodiment of a shared memory apparatus with multiple USB devices coupled to the shared memory apparatus. A representative selection of common personal consumer electronic devices configured with an USB interface is depicted in FIG. 1. However, it should be appreciated that virtually any USB device can be coupled to the shared memory apparatus. The devices depicted in FIG. 1 include: tablet 104, smartphone 106, laptop 108, tablet 110, and mobile device 112. Each USB device is coupled to shared memory apparatus 102 via a USB port on each USB enabled device and a plurality of USB ports on shared memory apparatus 102. Shared memory apparatus 102 can be powered by an external power source. The external power source can provide power to operate shared memory apparatus 102 and/or provide power for charging the devices coupled to shared memory apparatus 102. In addition, shared memory apparatus 102 can include optional battery power supply 114. Optional battery power supply 114 can be configured as a backup power supply to preserve volatile memory such as Random Access Memory (RAM) and/or can be configured with sufficient capacity to provide power for charging devices coupled to shared memory apparatus 102.

Shared memory apparatus 102 is also configured to provide memory arbitration. As the number of devices coupled to shared memory apparatus 102 increases, the need for memory arbitration becomes increasingly apparent. When one device, such as tablet 104, is coupled to shared memory apparatus 102, read-write access is almost always available to tablet 104. When several devices such as tablet 104, smartphone 106, and laptop 108 are coupled to shared memory apparatus 102, memory arbitration controls which device can access memory at a give time, thus, preventing each device from attempting to access memory at the same time.

Shared memory apparatus 102 can also provide read only access to general connected devices and reserve write access to specific devices. For example, software that needs to be disseminated to other devices can be uploaded to the shared memory apparatus 102 by a specific device with access privileges. Once uploaded, general devices that connect to the shared memory apparatus 102 can trigger a software download activity of the uploaded software. This allows, for example, an easy distribution of software such as drivers and the like that can be required for devices to interact with the shared memory apparatus 102 and/or other interconnected devices. It also allows updates to software to occur in a controlled manner.

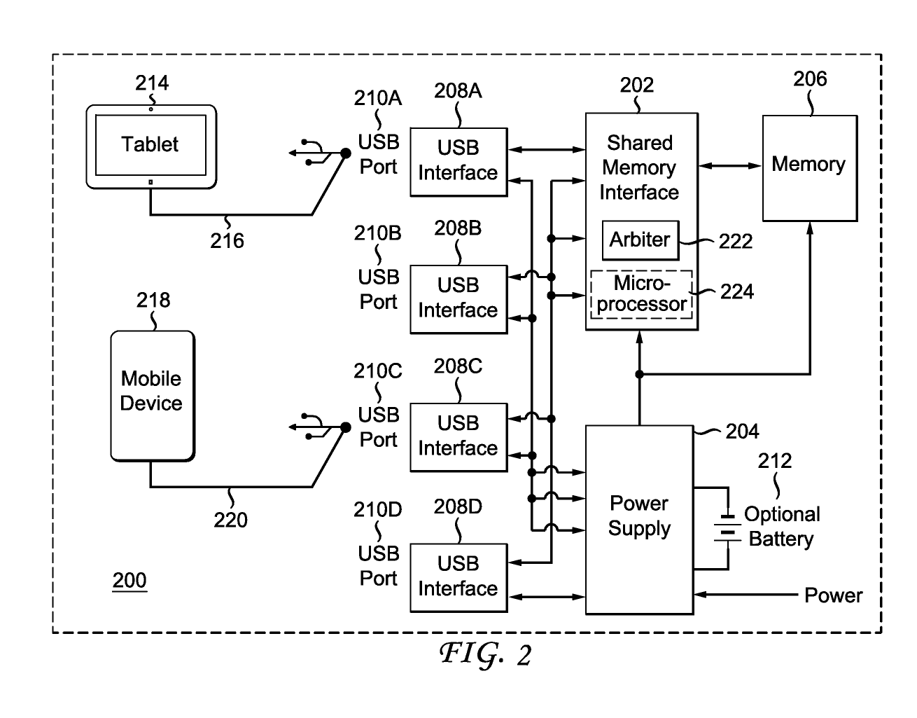

FIG. 2 depicts an example embodiment of a shared memory apparatus. Shared memory apparatus 200 includes memory interface 202, memory arbiter 222, power supply 204, memory 206, and USB interfaces 208A-208D. Each USB interface includes a USB port. Accordingly, USB ports 210A-210D correspond to USB interfaces 208A-208D. Also depicted is an optional battery power source 212. Power supply 204 is the primary power source for memory interface 202, memory arbiter 222, and memory 206. Memory 206 can be implemented as non-volatile memory such as flash memory, as volatile memory such as Random Access Memory (RAM), or a combination of non-volatile and volatile memory. Non-volatile memory is memory that retains stored information without power. Volatile memory, on the other hand, is memory that requires power to maintain stored information. In addition to providing power for memory interface 202, memory arbiter 222, and memory 206, power supply 204 provides power for USB devices connected to USB ports 210A-210D via USB interfaces 208A-208D.

In an example embodiment, optional battery power source 212 can be configured as a backup power source to preserve volatile memory such as RAM when power supply 204 is interrupted. In addition, optional battery power source 212 can be configured with sufficient capacity to provide power for USB charging devices coupled to shared memory apparatus 200. Power supply 204 can be configured to charge the battery/batteries of optional battery power source 212.

A USB device can be coupled to shared memory apparatus 200 by a USB cable connected to a USB port. Referring to FIG. 2, Tablet 214 is coupled to shared memory apparatus 200 by plugging USB cable 216 into USB port 210A, and mobile device 218 is coupled to shared memory apparatus 200 by plugging USB cable 220 into USB port 210C. The USB enumeration process is started when Tablet 214 is coupled to shared memory apparatus 200 through USB port 210A. A separate USB enumeration process is started when mobile device 218 is coupled to shared memory apparatus 200 through USB port 210C. The enumeration process includes: detecting the device, identifying the speed of the device, getting device descriptors, resetting the device and assigning an address, getting configuration descriptors, getting interface descriptors, and loading device drivers.

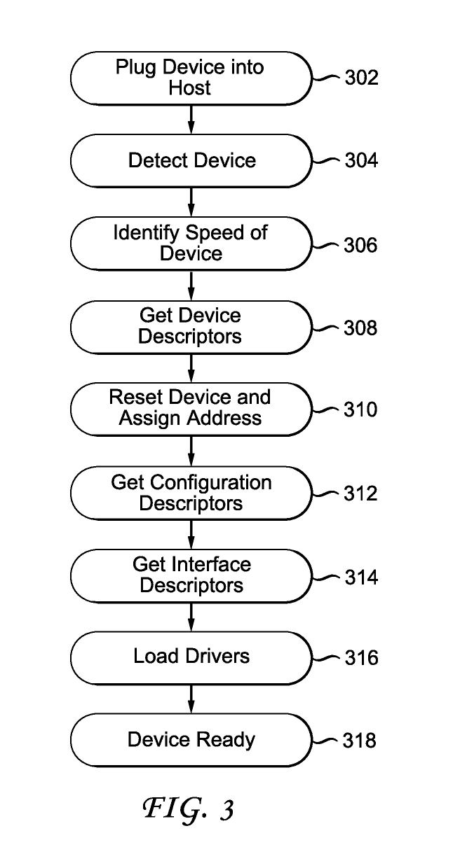

Referring to FIG. 3, an example USB enumeration process is illustrated. The enumeration process begins when a USB device is plugged into a host. At 302, a USB enabled device is coupled to a USB host. The host detects the presence of a device at 304, and the host can detect the device by a change in USBDP and USBDM data lines. The speed of the device is identified at 306. The device speed can be identified by the value of a pull-up resister between the data lines and Vcc and whether the resistor is on the USBDM or USBDP data line. Next, at 308, the device descriptor is used to determine what device is coupled to the host. To get the device descriptor the host will reset the USB device and attempt to read the descriptors using a default address. This process is akin to a question and answer process and is done to identify the USB device. The USB host sends a Get_Device_Descriptor command and receives a packet with the descriptor length and the actual descriptor. Once this is completed, at 310, the device is reset and given a unique address. The host then gets the configuration descriptors at 312. The configuration descriptors provide device specific information such as the number of interfaces supported by the device and the maximum power the device is expected to use. Next, at 314, the host gets interface descriptors. Once the host has fully identified the USB device, the host will determine a device driver needed to control the device. The host can determine the device driver by matching the USB device to a driver. The host can match a USB device to a driver using the Vendor ID (VID) and Product ID (PID) of the USB device. At 316, the device driver is loaded. After the USB device driver is loaded, the USB device is ready for use, 318. Once a USB device driver is loaded, the settings can be saved so that the next time the USB device is coupled to the host, the driver can be automatically loaded.

Referring now to FIG. 2, USB interface 208A is electrically coupled to power supply 204 and memory interface 202. As described in USB Power Delivery Specification Rev. 2.0, power delivery and USB battery charging operations coexist and are provided through the USB interface, in this example USB interface, 208A-208D. Tablet 214 has access to memory 206 through USB interface 208A and memory interface 202, and mobile device 218 has access to memory 206 through USB interface 208C and memory interface 202. Tablet 214, mobile device 218, as well as USB devices connected to USB interface 208B and 208D can all have read/write access to memory 206. Memory interface 202 can include memory arbiter 222. Tablet 214 and mobile device 218 are coupled to memory interface 202, and memory arbiter 222 controls when tablet 214 and mobile device 218 can access memory 206 at a given time period. The given time period can be defined by a memory cycle. When USB devices are coupled through USB interfaces 208A-208D, memory arbiter 222 controls which USB device can access memory 206 at a given time period. Memory arbiter 222 can also control the portion of memory where a USB device can perform read/write operations. Memory 206 can be read/write memory that allows data to be retrieved (read) and stored (written) during a memory cycle. This can be performed by a read/write operation or by separate read and write operations. A memory cycle is based on a fixed time period. Accordingly, the given time period can be defined as a memory cycle. Since multiple processors or devices cannot execute read/write operations at the same time, memory arbiter 222 controls which device can access memory 206 during a given time period.

Memory interface 202 can optionally include microprocessor 224. Microprocessor 224 can be provided for operation and configuration settings of shared memory apparatus 200. A USB host controls the USB interface and is referred to as a master. By default, shared memory apparatus 200 is a host device. A USB device that connects to the USB host is referred to as a slave. By default, USB enabled devices such as tablet 214 and mobile device 218 coupled to shared memory apparatus 200 are slave devices.

Shared memory apparatus 200 can be configured to synchronize USB devices. Shared memory apparatus can be configured to synchronize USB devices automatically or manually. In addition, synchronization can be configured using application software residing on a USB device coupled to shared memory apparatus. For example, tablet 214 can be coupled to shared memory apparatus 200 through USB port 210A and running application software providing synchronization operations. Tablet 214 can configure the application software to synchronize with mobile device 218 as soon as mobile device 218 is coupled to shared memory apparatus 200. Another option can include tablet 214 running application software to synchronize with mobile device 218 manually when mobile device 218 is coupled to shared memory apparatus 200.

In an alternative example embodiment, a USB device coupled to shared memory apparatus 200 can function as the master. For example, tablet 214 can run application software and operate as the master. Tablet 214 can function as a master while other USB devices, such as mobile device 218 coupled to shared memory apparatus 200, are slave devices.

In yet another example embodiment, a USB device coupled to shared memory apparatus 200 functioning as the master can run application software enabling the USB enabled device to be a memory arbiter. For example, tablet 214 can be designated the master while mobile device 218 is a slave device, and the function of memory arbiter 222 can be provided by tablet 214. Accordingly, tablet 214 will control which USB device can access memory 206 at a given time period.

Example embodiments of the invention include a shared memory apparatus for coupling at least one Universal Serial Bus (USB) device, the shared memory apparatus comprising: at least one USB interface; a memory accessible via the at least one USB interface wherein the memory is configured to be shared between the at least one USB device, the memory configured with a memory arbiter, wherein the memory arbiter decides which of the at least one USB device can access a read-write memory space of the memory during a time period.

In another example embodiment, the shared memory apparatus is further configured to provide power to the at least one USB device via the at least one USB interface.

In another example embodiment, the memory is implemented with a semaphore.

In another example embodiment, the at least one USB device exchanges information with at least a second USB device via the memory.

In another example embodiment, the at least one USB device and at least a second USB device exchange synchronize information via the memory.

In yet another example embodiment, memory arbitration is provided by a USB device designated as a master device and coupled to the shared memory apparatus.

In another example embodiment, the memory is non-volatile memory. Another example embodiment can implement memory as volatile memory.

In an alternative embodiment, the at least one USB interface is configured as a wireless USB interface.

In another example embodiment, the shared memory apparatus further comprises a microprocessor.

Another example embodiment of the invention includes a method for interfacing at least one Universal Serial Bus (USB) device with a shared memory apparatus, the method comprising: coupling the at least one USB device to the shared memory apparatus via a USB port, wherein the shared memory apparatus is configured with a plurality of USB ports and a memory; and deciding, by a memory arbiter, which of the at least one USB device can access a read-write memory space of the memory during a time period.

As used in this application, the term “circuitry” refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions; and (c) circuits, such as a microprocessor(s) or a portion of a microprocessor(s), that require software or firmware for operation, even if the software or firmware is not physically present. This definition of “circuitry” applies to all uses of the term in this application, including in any claims. As a further example, as used in this application, the term “circuitry” would also cover an implementation of merely a processor (or multiple processors) or portion of a processor and its (or their) accompanying software and/or firmware. The term “circuitry” also would cover, if applicable to the particular claim element, a baseband integrated circuit, or applications processor integrated circuit, for a mobile phone or a similar integrated circuit in server, a cellular network device, or other network device.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs) as well as unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The foregoing description should therefore be considered as merely illustrative of the principles, teachings and example embodiments of this invention, and not in limitation thereof

Further, some of the various features of the above non-limiting embodiments may be used to advantage without the corresponding use of other described features. While the invention has been described in conjunction with specific embodiments, one of ordinary skill in the art appreciates that there are many variations that are in accordance with the foregoing description and remain within the scope of the appended claim set. All of the features described above or shown in the drawings can be advantageously combined with one another within the framework of the invention. Accordingly, it is intended that the present invention embrace all such alternatives, modifications and variations as fall within the scope of the appended claims.

What is claimed is:

1. A shared memory apparatus for coupling with at least one Universal Serial Bus (USB) device, the shared memory apparatus comprising:
at least one USB interface;
a memory accessible via the at least one USB interface, wherein the memory is configured to be shared between the at least one USB device, the memory configured with a memory arbiter, wherein the memory arbiter decides which of the at least one USB device can access at least a portion of the memory.

2. The shared memory apparatus of claim 1, further configured to provide power to the at least one USB device via the at least one USB interface.

3. The shared memory apparatus of claim 1, wherein the memory arbiter is implemented with a semaphore.

4. The shared memory apparatus of claim 1, wherein the at least one USB device and at least a second USB device exchange information via the memory.

5. The shared memory apparatus of claim 1, wherein the at least one USB device and at least one other USB device synchronize information via the memory.

6. The shared memory apparatus of claim 1, wherein a USB device designated as a master device and coupled to the shared memory apparatus is configured as a separate memory arbiter.

7. The shared memory apparatus of claim 1, wherein the memory is non-volatile memory.

8. The shared memory apparatus of claim 1, wherein a time period allowed for access to the memory is a memory cycle.

9. The shared memory apparatus of claim 1, wherein the at least one USB interface is a wireless USB interface.

10. The shared memory apparatus of claim 1, further comprising a microprocessor.

11. A method for interfacing at least one Universal Serial Bus (USB) device with a shared memory apparatus, the method comprising:
coupling the at least one USB device to the shared memory apparatus via a USB port wherein the shared memory apparatus is configured with a plurality of USB ports and a memory;
deciding, by a memory arbiter, which of the at least one USB device can access at least a portion of the memory during a time period.

12. The method of claim 11, further comprising providing power to the at least one USB device through the USB port.

13. The method of claim 11, wherein the memory arbiter is implemented with a semaphore.

14. The method of claim 11, wherein a USB device designated as a master device and coupled to the shared memory apparatus is a separate memory arbiter.

15. The method of claim 11, wherein the memory is configured to provide synchronization between the at least one USB device and at least one other USB device.

16. The method of claim 11, wherein the time period is a memory cycle.

17. A system for interfacing USB devices, the system comprising:
at least one USB interface; and
a memory accessible via the at least one USB interface, the memory having a memory arbiter wherein the memory arbiter controls access to the memory from the at least one USB interface.

18. The system of claim 17, wherein access to the memory comprises access to a portion of the memory for read/write operations.
